(19) United States
(12) Patent Application Publication
(10) Pub. No.: US 2026/0063963 A1
(43) Pub. Date: Mar. 5, 2026

(54) ELECTROPHORETIC DISPLAY DEVICE

(71) Applicant: E Ink Holdings Inc., Hsinchu (TW)

(72) Inventors: Jau-Min Ding, Hsinchu (TW); Wen-Heng Huang, Hsinchu (TW); Po-Yuan Lo, Hsinchu (TW); Ian French, Hsinchu (TW)

(73) Assignee: E Ink Holdings Inc., Hsinchu (TW)

(21) Appl. No.: 19/241,321

(22) Filed: Jun. 17, 2025

(30) Foreign Application Priority Data
Sep. 3, 2024 (TW) 113133171

(51) Int. Cl. G02F 1/1677; G02F 1/167; G02F 1/16762

(52) U.S. Cl. CPC G02F 1/1677; G02F 1/167; G02F 1/16762

(57) ABSTRACT

An electrophoretic display device includes a pixel structure and a color filter array. In the pixel structure, an area of a blue pixel electrode is less than an area of a red pixel electrode, and the area of the blue pixel electrode is less than an area of a green pixel electrode. In the color filter array, areas of red, green, and blue filter units are all substantially the same and the red, green, and blue filter units are overlapped with the red, green, and blue pixel electrodes respectively. A ratio of the area of the red filter unit to the area of the red pixel electrode is RFF; a ratio of the area of the green filter unit to the area of the green pixel electrode is GFF; a ratio of the area of the blue filter unit to the area of the blue pixel electrode is BFF, and BFF>RFF≥GFF.

### CROSS-REFERENCE TO RELATED APPLICATION

This application claims the priority benefit of Taiwan application serial no. 113133171, filed on Sep. 3, 2024. The entirety of the above-mentioned patent application is hereby incorporated by reference herein and made a part of this specification.

### BACKGROUND OF THE INVENTION

### Field of the Invention

The invention relates to a display device, and in particular to an electrophoretic display device.

### Description of Related Art

Electrophoretic display devices have advantages such as light weight, thin, good durability, and power-saving. Issues such as environmental protection and energy conservation are receiving more attention today. This environmental, social, and governance (ESG) trend accelerates the spread of electrophoretic display devices in electronic readers (for example, e-books, electronic newspapers) and electronic shelf labels (ESL) markets. In addition, color electrophoretic display device techniques that can display a variety of colors have become the focus of attention. They keep attracting research and development activities of relevant manufacturers.

However, the display brightness of reflective displays is usually dimmer compared to displays having backlights or self-illuminating displays. Due to the lack of emissive light sources, the display brightness thereof is related to the ambient lighting conditions and the reflectivity of the display material. As a result, reflective displays show difficulty in displaying brighter colors, such as yellow. Low color brightness and low color purity cause a reduction in contrast and affect the viewing experience of the user.

### SUMMARY OF THE INVENTION

The invention provides an electrophoretic display device having better color contrast and color purity.

An embodiment of the invention provides an electrophoretic display device including a pixel structure and a color filter array. In the pixel structure, an area of a blue pixel electrode is less than an area of a red pixel electrode, and the area of the blue pixel electrode is less than an area of a green pixel electrode. In the color filter array, an area of a red filter unit, an area of a green filter unit, and an area of a blue filter unit are all substantially the same and the red filter unit, the blue filter unit, and the green filter unit are overlapped with the red pixel electrode, the green pixel electrode, and the green pixel electrode, respectively. A ratio of the area of the red filter unit to the area of the red pixel electrode is RFF; a ratio of the area of the green filter unit to the area of the green pixel electrode is GFF; a ratio of the area of the blue filter unit to the area of the blue pixel electrode is BFF, and BFF>RFF≥GFF.

In an embodiment of the invention, the electrophoretic display device further satisfies following conditional expressions: RFF≤75%; GFF≤62.5%; and BFF≤93.7%.

In an embodiment of the invention, the electrophoretic display device further satisfies following conditional expressions: RFF≤63%; GFF≤63%; and BFF≤100%.

In an embodiment of the invention, the electrophoretic display device further satisfies following conditional expressions: RFF≤67%; GFF≤60%; and BFF≤100%.

In an embodiment of the invention, a display surface of the electrophoretic display device has a first direction and a second direction perpendicular to each other. The blue pixel electrode is extended in the first direction and the second direction respectively, so that an outline of the red pixel electrode adjacent to the blue pixel electrode and an outline of the green pixel electrode adjacent to the blue pixel electrode are both receded in a direction away from the blue pixel electrode.

In an embodiment of the invention, the outline of the blue pixel electrode is a cross shape. Two vertical ends of the cross shape are extended toward the first direction and the second direction respectively.

In an embodiment of the invention, a display surface of the electrophoretic display device has a first direction and a second direction perpendicular to each other. The red pixel electrode, the green pixel electrode, and the blue pixel electrode all have a same width in the first direction, and the red pixel electrode, the green pixel electrode, and the blue pixel electrode are all extended in the second direction.

In an embodiment of the invention, an outline of the blue pixel electrode is essentially a circle. An outline of the red pixel electrode adjacent to the blue pixel electrode and an outline of the green pixel electrode adjacent to the blue pixel electrode are both receded in a direction away from the blue pixel electrode.

In an embodiment of the invention, another red pixel electrode is further included, wherein a display surface of the electrophoretic display device has a first direction and a second direction perpendicular to each other, and the red pixel electrode and the another red pixel electrode are respectively located in the first direction and the second direction of the blue pixel electrode. The blue pixel electrode is extended toward the red pixel electrode and toward the another red pixel electrode, so that an outline of the red pixel electrode adjacent to the blue pixel electrode and an outline of the another red pixel electrode are both receded in a direction away from the blue pixel electrode.

In an embodiment of the invention, the blue pixel electrode is extended toward the red pixel electrode, so that an outline of the red pixel electrode adjacent to the blue pixel electrode is receded in a direction away from the blue pixel electrode.

In an embodiment of the invention, a shape of the red filter unit is substantially the same as a shape of the red pixel electrode, a shape of the green filter unit is substantially the same as a shape of the green pixel electrode, and a shape of the blue filter unit is substantially the same as a shape of the blue pixel electrode.

In an embodiment of the invention, the green pixel electrode is extended toward the blue pixel electrode, so that an outline of the blue pixel electrode adjacent to the green pixel electrode is receded in a direction away from the green pixel electrode.

In an embodiment of the invention, the electrophoretic display device further includes an electrophoretic display film disposed between the pixel structure and the color filter array. The electrophoretic display film includes a microcapsule electrophoretic structure or a microcup electrophoretic structure.

Based on the above, in an embodiment of the invention, since the area of the green pixel electrode and the area of the red pixel electrode are both greater than the area of the blue pixel electrode, the green patterns and the yellow patterns displayed by the electrophoretic display device can be brighter, and at the same time the blue patterns displayed can be darker, thus effectively improving the contrast and the chroma of the display screen. Moreover, since the area of the red filter unit, the area of the green filter unit, and the area of the blue filter unit are all substantially the same, the pixel coverage (i.e., BFF) of the blue filter unit is greater than the pixel coverage (i.e., GFF) of the green filter unit and the pixel coverage (i.e., RFF) of the red filter unit. Therefore, while adjusting the brightness of the display of the primary color light, the white balance of the electrophoretic display device can be maintained to alleviate the color shift issue of the electrophoretic display device, and to effectively improve the contrast and the display quality of the electrophoretic display device.

In order to make the aforementioned features and advantages of the disclosure more comprehensible, embodiments accompanied with figures are described in detail below.

### BRIEF DESCRIPTION OF THE DRAWINGS

FIG. 1A is a schematic top view of a pixel structure and a color filter array of an electrophoretic display device according to an embodiment of the invention.

FIG. 1B is a schematic cross-sectional structural view of an electrophoretic display device according to the embodiment of FIG. 1A along section line I-I′.

FIG. 2 is a schematic top view of a pixel structure and a color filter array of an electrophoretic display device of an embodiment of the invention.

FIG. 3 is a schematic top view of a pixel structure and a color filter array of an electrophoretic display device of an embodiment of the invention.

FIG. 4 is a schematic top view of a pixel structure and a color filter array of an electrophoretic display device of an embodiment of the invention.

FIG. 5 is a schematic top view of a pixel structure and a color filter array of an electrophoretic display device of an embodiment of the invention.

FIG. 6 is a schematic top view of a pixel structure and a color filter array of an electrophoretic display device of an embodiment of the invention.

FIG. 7 is a schematic top view of a pixel structure and a color filter array of an electrophoretic display device of an embodiment of the invention.

FIG. 8 is a schematic top view of a pixel structure and a color filter array of an electrophoretic display device of an embodiment of the invention.

FIG. 9 is a schematic top view of a pixel structure and a color filter array of an electrophoretic display device of an embodiment of the invention.

FIG. 10 is a schematic top view of a pixel structure and a color filter array of an electrophoretic display device of an embodiment of the invention.

FIG. 11 is a schematic top view of a pixel structure and a color filter array of an electrophoretic display device of an embodiment of the invention.

### DESCRIPTION OF THE EMBODIMENTS

The directional terms mentioned herein, such as upper, lower, front, rear, left, right, etc., refer to the directions of the drawings. Accordingly, the directional terms used are illustrative, not limiting, of the invention.

In the drawings, each drawing depicts general features of methods, structures, and/or materials used in specific embodiments. The drawings should not be interpreted as defining or limiting the scope or nature encompassed by the embodiments. For example, the relative sizes, thicknesses, and locations of various layers, regions, and/or structures may be reduced or exaggerated for clarity.

In the following embodiments, the same or similar elements are given the same or similar reference numerals, and descriptions thereof are omitted. Moreover, features of different embodiments may be combined with each other without conflict, and simple equivalent changes and modifications made in accordance with this specification or the claims are still within the scope of this patent.

Terms such as first and second, mentioned in the specification or the claims are only used to name discrete elements or to distinguish different embodiments or scopes and are not used to limit the upper limit or the lower limit of the quantity of elements, nor are they used to limit the manufacturing sequence or the arrangement sequence of the elements. In addition, one element/film layer being disposed on (or above) another element/film layer may indicate that the element/film layer is directly disposed on (or above) the another element/film layer, and the two elements/film layers are in direct contact; and the element/film layer is indirectly disposed on (or above) the another element/film layer, and there are one or a plurality of elements/film layers between the two elements/film layers.

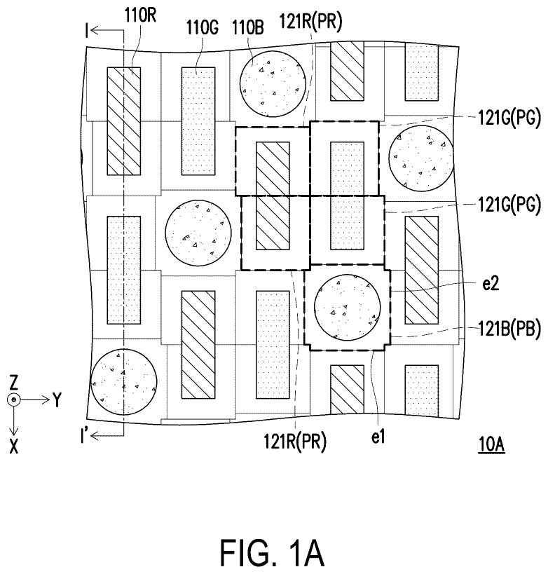

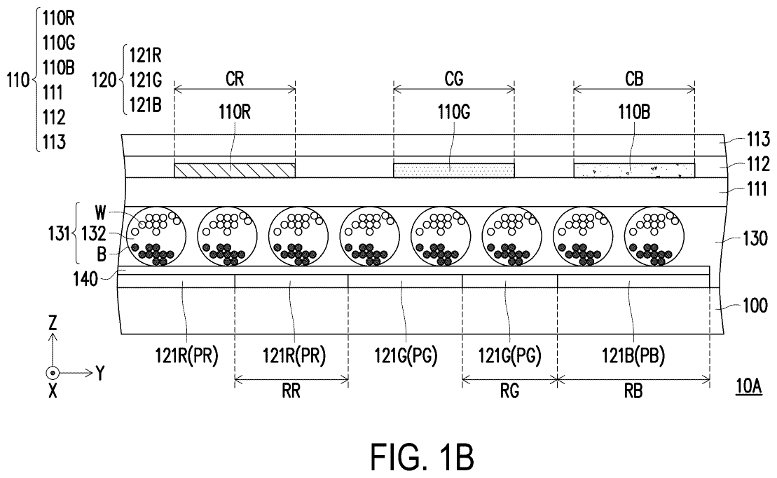

FIG. 1A is a schematic top view of a pixel structure and a color filter array of an electrophoretic display device according to an embodiment of the invention. FIG. 1B is a schematic cross-sectional structural view of an electrophoretic display device according to the embodiment of FIG. 1A along section line I-I′. For convenience of explanation, FIG. 1A omits some elements (e.g., an electrophoretic display film 130 and an insulating layer 140) in an electrophoretic display device 10A. Please refer to FIG. 1A and FIG. 1B simultaneously. The electrophoretic display device 10A includes a substrate 100, a color filter array 110, a pixel structure 120, the electrophoretic display film 130, and the insulating layer 140. The color filter array 110 and the pixel structure 120 are overlapped, and the electrophoretic display film 130 is disposed between the color filter array 110 and the pixel structure 120.

The substrate 100 is, for example, an active element array substrate, such as a thin-film transistor (TFT) array substrate or a thin-film diode (TFD) array substrate and includes corresponding data lines and scan lines for driving the pixel structure 120.

The color filter array 110 includes a red filter unit 110R, a green filter unit 110G, a blue filter unit 110B, a filter substrate 111, an adhesive layer 112, and a cover plate 113. The red filter unit 110R, the green filter unit 110G, and the blue filter unit 110B are alternately arranged in an array in a first direction X and a second direction Y, respectively, and each include corresponding red filter material, green filter material, and blue filter material, so that when reflected ambient light passes through each of the filter units, corresponding red light, green light, and blue light may be provided. The filter substrate 111 may include a counter electrode (such as a common electrode, not shown) to provide a desired electric field to drive a display medium (described later) in the electrophoretic display film 130. The adhesive layer 112 may be optically transparent adhesive to adhere the cover plate 113 and the filter substrate 111 to each other. In other embodiments, the color filter array 110 may also include a touch electrode layer (not shown) to enable the electrophoretic display device 10A to have a touch sensing function, but the invention is not limited thereto. In addition, in each diagram of the article, color filter units of the same color are all drawn with the same pattern and repeated reference numerals are omitted. For example, in each of the figures, the diagonal line patterns all represent the red filter unit 110R, the dotted patterns all represent the green filter unit 110G, and the mixed dotted and triangular patterns all represent the blue filter unit 110B. The above is not repeated herein.

It is worth mentioning that in the present embodiment, in a third direction Z, on the projection surface of the electrophoretic display device 10A, an area CR of the red filter unit 110R, an area CG of the green filter unit 110G, and an area CB of the blue filter unit 110B may all be substantially the same. Moreover, in the following description, the third direction Z may represent the display direction of the electrophoretic display device 10A, and the area of the element refers to the projection area of the electrophoretic display device 10A in the third direction Z, and is not described again here. In other words, FIG. 1A may also be regarded as a schematic top view of the display area of the electrophoretic display device 10A. In addition, in the present embodiment, the first direction X, the second direction Y, and the third direction Z may be substantially perpendicular to each other, but the invention is not limited thereto. In other embodiments, there may be other angles between the first direction X, the second direction Y, and the third direction Z.

The pixel structure 120 includes a plurality of red pixel electrodes PR, green pixel electrodes PG, and blue pixel electrodes PB respectively applied with a driving voltage to drive the electrophoretic display material layer in the electrophoretic display film 130. Specifically, each of the red pixel electrodes PR may be defined by two red sub-pixels 121R, each of the green pixel electrodes PG may be defined by two green sub-pixels 121G, and each of the blue pixel electrodes PB may be defined by one blue sub-pixel 121B. Therefore, from another perspective, the area of one red pixel electrode PR may be defined as the sum of areas RR of the two red sub-pixels 121R; the area of one green pixel electrode PG may be defined as the sum of areas RG of the two green sub-pixels 121G; and the area of one blue pixel electrode PB may be defined as an area RB of the one blue sub-pixel 121B. Therefore, in the present embodiment, the green pixel electrodes PG and the red pixel electrodes PR may both be extended in the first direction X. That is, both the green pixel electrodes PG and the red pixel electrodes PR may have a greater length (as shown in FIG. 1A) in the first direction X.

The insulating layer 140 is disposed between the pixel structure 120 and the electrophoretic display film 130. It should be mentioned that, every two of the red pixel electrode PR, the green pixel electrode PG, and the blue pixel electrode PB may be separated by the insulating layer 140 to achieve the object of electrically independently controlling the red pixel electrodes PR, the green pixel electrodes PG, and the blue pixel electrodes PB. For convenience of explanation, the drawing of the insulating layer 140 between every two of the red pixel electrodes PR, the green pixel electrodes PG, and the blue pixel electrodes PB is omitted in each figure.

The electrophoretic display film 130 is disposed on the pixel structure 120. In the present embodiment, the electrophoretic display film 130 is an electrophoretic display material layer, and may include, for example, a microcapsule electrophoretic structure or a microcup electrophoretic structure, and the invention is not limited thereto. In the present embodiment, the electrophoretic display film 130 adopts a microcapsule electrophoretic structure as an exemplary illustration. For example, the electrophoretic display film 130 may include a plurality of microcapsule structures 131, and each of the microcapsule structures 131 includes an electrophoretic liquid 132, a plurality of black charged particles B, and a plurality of white charged particles W. An electric field is generated via a common voltage provided by a common electrode and a driving voltage provided by a pixel electrode disposed opposite to each other in the third direction Z, so that the plurality of black charged particles B or the plurality of white charged particles W are moved to the top of the microcapsule structure 131, and the electrophoretic display film 130 may absorb ambient light or reflect ambient light. When the reflected ambient light passes through the red filter unit 110R, the green filter unit 110G, and the blue filter unit 110B of the color filter array 110, red image light, green image light, or blue image light may be provided. Of course, the invention is not limited thereto. In other embodiments not shown, each of the microcapsule structures 131 of the electrophoretic display film 130 may also include charged particles of other colors.

The electrophoretic display device 10A may also be provided with a front light module above the color filter array 110 according to actual needs. The front light module includes, for example, solid transparent optical adhesive, light guide plate, protective glass, etc. (all are not shown). Those skilled in the art may match the above elements with the electrophoretic display device 10A, and the invention is also not limited thereto.

It should be mentioned that, compared with the conventional pixel structure in which the areas of all pixel electrodes are the same (for example, the red pixel electrode is one red sub-pixel 121R, the green pixel electrode is one green sub-pixel 121G, and the blue pixel electrode is one blue sub-pixel 121B, and are all rectangles in the same area), in the pixel structure 120 of the invention, the areas of the blue pixel electrodes PB are less than the areas of the red pixel electrodes PR, and the areas of the blue pixel electrodes PB are less than the areas of the green pixel electrodes PG.

For example, the red pixel electrodes PR, the green pixel electrodes PG, and the blue pixel electrodes PB are closely arranged with each other, and the blue pixel electrodes PB of the present embodiment may be extended in the first direction X and the second direction Y respectively and have a first end e1 and a second end e2 perpendicular to each other. The extension of the blue pixel electrodes PB causes the outline of the red pixel electrodes PR adjacent thereto to be receded in a direction away from the blue pixel electrodes PB. Similarly, the outline of the green pixel electrodes PG adjacent to the blue pixel electrodes PB is also receded in a direction away from the blue pixel electrodes PB. From another perspective, compared to the red sub-pixels 121R, the green sub-pixels 121G, and the blue sub-pixels 121B that are all squares of the same size, in the present embodiment, the blue pixel electrodes PB may have a cross shape, and the first end e1 and the second end e2 of the cross shape are respectively extended toward the adjacent green sub-pixels 121G and toward the adjacent red sub-pixels 121R, so that the area RB of one blue sub-pixel 121B is greater than the area RR of one red sub-pixel 121R and greater than the area RG of one green sub-pixel 121G.

It should be noted that, unless otherwise specified in the article, “the A-order pixel and the B-order pixel are adjacent” means that there are no other sub-pixels between the A-order pixel and the B-order pixel. Similarly, “the A pixel electrode and the B pixel electrode are adjacent” means that there are no other pixel electrodes between the A pixel electrode and the B pixel electrode, which is not repeated herein.

For example, if the area RR of one red sub-pixel 121R is 0.95 units, the area of one red pixel electrode PR is 0.95*2=1.9 units. Similarly, if the area RG of one green sub-pixel 121G is 0.95 units, the area of one green pixel electrode PG is 0.95*2=1.9 units. The area RB of one blue sub-pixel 121B (that is, the area of one blue pixel electrode PB) is 1+0.05*4-1.2 units. In other words, compared with the conventional red pixel electrodes, green pixel electrodes, and blue pixel electrodes for which the areas are equal (the proportions account for 33.3%, 33.3%, and 33.3% of one pixel respectively), in an embodiment of the invention, the areas of the red pixel electrodes PR, the areas of the green pixel electrodes PG, and the areas of the blue pixel electrodes PB may respectively account for 38%, 38%, and 24% of one pixel. Therefore, the higher area ratio of the red pixel electrodes PR and the higher area ratio of the green pixel electrodes PG make the red light and the green light reflected by the electrophoretic display device 10A to be brighter and the blue light to be darker, further improving the contrast of the display screen. Of course, the invention is not limited thereto. In other embodiments, the areas of the red pixel electrodes PR, the areas of the green pixel electrodes PG, and the areas of the blue pixel electrodes PB may be other ratios respectively.

Based on the above, the area CR of the red filter unit 110R, the area CG of the green filter unit 110G, and the area CB of the blue filter unit 110B are all substantially the same. When the ratio of the area CB of the blue filter unit 110B to the areas RB of the blue pixel electrodes PB is BFF (it may also be understood as the pixel coverage of the blue filter unit 110B or the fill factor of the blue pixels) and has the maximum value, the area CB may be equal to the areas RB, that is, both are 1.2 units. At this time, BFF may be 100%. Based on the above, the maximum value of the ratio RFF (it may also be understood as the pixel coverage of the red filter unit 110R or the fill factor of the red pixels) of the area CR of the red filter unit 110R to the areas of the red pixel electrodes PR is equal to (1.2/1.9)=63%, and the maximum value of the ratio GFF (it may also be understood as the pixel coverage of the green filter unit 110G or the fill factor of the green pixels) of the area CG of the green filter unit 110G to the areas of the green pixel electrodes PG is equal to (1.2/1.9)=63%. It may also be understood that for the electrophoretic display device 10A, RFF≤63%; GFF≤63%; and BFF≤100%. Since BFF is greater than RFF and GFF, the electrophoretic display device 10A has high contrast and may readily maintain the white balance of the display screen, thereby alleviating the color shift issue of the display screen.

As a comparative example, if the red sub-pixels 121R, the green sub-pixels 121G, and the blue sub-pixels 121B are all squares of the same size (for example, the areas are all 1 unit), and the blue filter unit 110B (the area is 1 unit) corresponds to one blue sub-pixel 121B, the red filter unit 110R (the area is 1 unit) corresponds to two red sub-pixels 121R, and the green filter unit 110G (the area is 1 unit) corresponds to 2 green sub-pixels 121G, for such an electrophoretic display device, the maximum value of RFF is (1/2)=50%; the maximum value of GFF is (1/2)=50%; and the maximum value of BFF is (1/1)=100%. Higher pixel coverage means higher brightness. In other words, on the basis of maintaining the white balance, the electrophoretic display device 10A of the present embodiment may further make the reflected red light and green light brighter, further improving the brightness of the display screen.

It should be mentioned that, the embodiments below adopt the same reference numerals and portions of the content from previous embodiments. Specifically, the same reference numerals are used to represent the same or similar elements, and the descriptions for the same techniques are omitted. The omitted portions are as described in the embodiments above and are not repeated in the following embodiment.

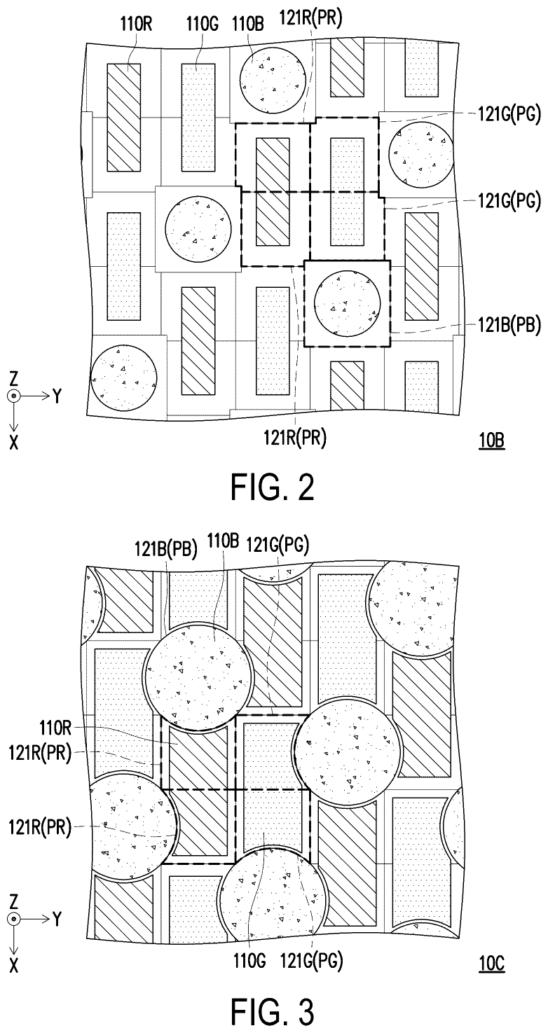

FIG. 2 is a schematic top view of a pixel structure and a color filter array of an electrophoretic display device of an embodiment of the invention. Please refer to FIG. 2. An electrophoretic display device 10B is similar to the electrophoretic display device 10A. The main difference thereof is the shape of the pixel electrodes is different. In the electrophoretic display device 10B, the outline of the blue pixel electrodes PB (or the blue sub-pixels 121B) may be a rectangle or a square. Therefore, the outline of the green pixel electrodes PG adjacent to the blue pixel electrodes PB is receded in a direction away from the blue pixel electrodes PB. For example, the outline of the adjacent green sub-pixels 121G is a rectangle with one corner missing. Similarly, the outline of the red pixel electrodes PR adjacent to the blue pixel electrodes PB is receded in a direction away from the blue pixel electrodes PB. For example, the outline of the adjacent red sub-pixels 121R is also a rectangle with one corner missing.

FIG. 3 is a schematic top view of a pixel structure and a color filter array of an electrophoretic display device of an embodiment of the invention. Please refer to FIG. 3. An electrophoretic display device 10C is similar to the electrophoretic display device 10A. The main difference thereof is the shapes of the pixel electrodes and the filter unit of each color are different. In the electrophoretic display device 10C, the outline of the blue pixel electrodes PB (or the blue sub-pixels 121B) may be the same as the blue filter unit 110B and both are circles, and the BFF is substantially 100%. Therefore, the outline of the green pixel electrodes PG adjacent to the blue pixel electrodes PB is receded in a direction away from the blue pixel electrodes PB. For example, the adjacent green sub-pixels 121G have an arc-shaped outline. Similarly, the outline of the red pixel electrodes PR adjacent to the blue pixel electrodes PB is receded in a direction away from the blue pixel electrodes PB. For example, the adjacent red sub-pixels 121R have an arc-shaped outline.

Moreover, in the present embodiment, the shape of the red filter unit 110R is the same as the shape of the red pixel electrodes PR (for example, both are rectangles having two arc-shaped notches), the shape of the green filter unit 110G is the same as the shape of the green pixel electrodes PG (for example, both are rectangles having two arc-shaped notches), and the shape of the blue filter unit 110B is the same as the shape of the blue pixel electrodes PB (for example, both are circles), so as to further improve the space utilization of the red filter unit 110R, the green filter unit 110G, and the blue filter unit 110B.

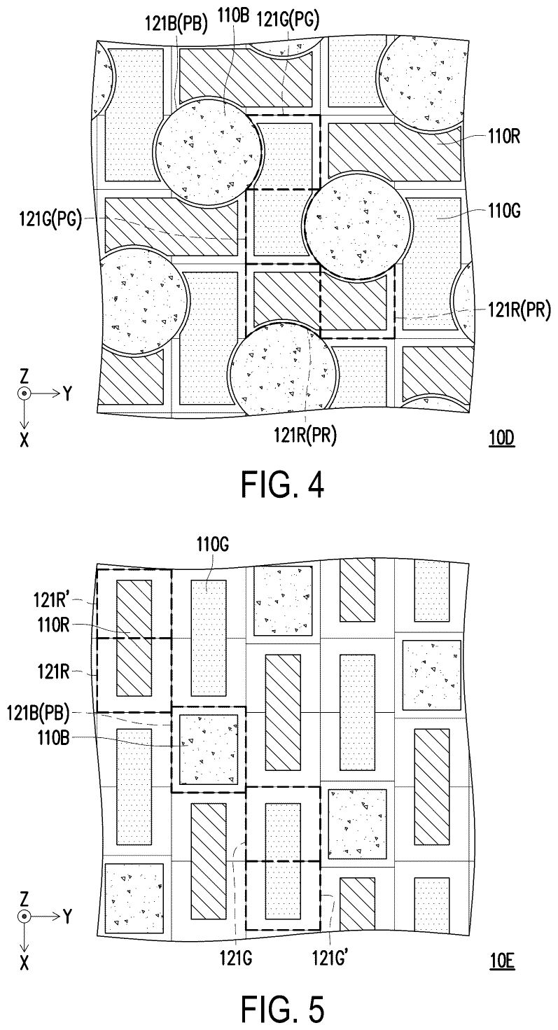

FIG. 4 is a schematic top view of a pixel structure and a color filter array of an electrophoretic display device of an embodiment of the invention. Please refer to FIG. 4. An electrophoretic display device 10D is similar to the electrophoretic display device 10C. The main differences thereof are: the extending direction of the green pixel electrodes PG is different from the extending direction of the red pixel electrodes PR, and the extending direction of the green filter unit 110G is different from the extending direction of the red filter unit 110R. Specifically, in the electrophoretic display device 10D, two green sub-pixels 121G may both be arranged in the first direction X, so that the green pixel electrodes PG and the green filter unit 110G have a greater length in the first direction X. In contrast, two red sub-pixels 121R may both be arranged in the second direction Y, so that the red pixel electrodes PR and the red filter unit 110R have a greater length in the second direction Y. That is, the extending directions of the green pixel electrodes PG and the red pixel electrodes PR may be perpendicular to each other.

FIG. 5 is a schematic top view of a pixel structure and a color filter array of an electrophoretic display device of an embodiment of the invention. Please refer to FIG. 5. An electrophoretic display device 10E is similar to the electrophoretic display device 10A. The main difference thereof is the extending direction of the blue pixel electrodes PB is different. Specifically, in the electrophoretic display device 10E, the red pixel electrodes PR, the green pixel electrodes PG, and the blue pixel electrodes PB all have the same width in the second direction Y. Moreover, the red pixel electrodes PR, the green pixel electrodes PG, and the blue pixel electrodes PB are all extended in the first direction X, i.e., the length is greater in the first direction X. In other words, the red pixel electrodes PR, the green pixel electrodes PG, and the blue pixel electrodes PB may all be rectangles. Moreover, in the present embodiment, the shape of the red filter unit 110R is the same as the shape of the red pixel electrodes PR, the shape of the green filter unit 110G is the same as the shape of the green pixel electrodes PG, and the shape of the blue filter unit 110B is the same as the shape of the blue pixel electrodes PB (for example, all are rectangles).

Furthermore, the blue sub-pixels 121B may be extended in the same direction and in the opposite direction of the first direction X, respectively, so that the areas of the blue pixel electrodes PB are greater (for example, 1.2 units) so that adjacent red sub-pixels 121R′ and adjacent green sub-pixels 121G′ are receded and smaller (for example, both are 0.9 units). The areas of the red pixel electrodes PR are the sum of the red sub-pixels 121R and the another red sub-pixel 121R′, for example, 1+0.9=1.9 (units). Similarly, the areas of the green pixel electrodes PG are the sum of the green sub-pixels 121G and the another green sub-pixel 121G′, and are for example, also 1+0.9=1.9 (units). Similar effects to the electrophoretic display device 10A may also be achieved, and are not repeated herein.

Furthermore, since the red pixel electrodes PR, the green pixel electrodes PG, and the blue pixel electrodes PB may all be rectangles, in the present embodiment, the edges in a direction (for example, the first direction X) may be smooth, so that the manufacturing difficulty of the pixel structure 120 and the color filter array 110 is reduced.

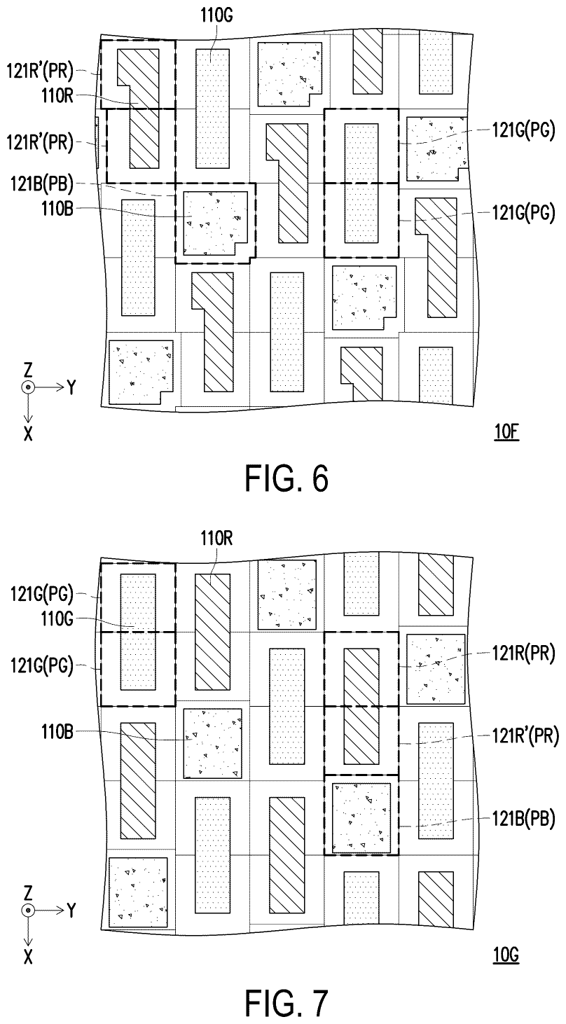

FIG. 6 is a schematic top view of a pixel structure and a color filter array of an electrophoretic display device of an embodiment of the invention. Please refer to FIG. 6. An electrophoretic display device 10F is similar to the electrophoretic display device 10A. The main difference thereof is the extending direction of the blue pixel electrodes PB is different. Specifically, in the electrophoretic display device 10F, the blue pixel electrodes PB (or the blue sub-pixels 121B) are extended toward the red pixel electrodes PR in the first direction X, and extended toward the red pixel electrodes PR in the second direction Y, but not extended toward the green pixel electrodes PG. The areas of the green pixel electrodes PG are greater than the areas of the red pixel electrodes PR. It may also be understood that the blue pixel electrodes PB cause the outline of the adjacent red pixel electrodes PR thereof and the outline of the another red pixel electrode PR to both be receded in a direction away from the blue pixel electrodes PB.

For example, in FIG. 6, the blue pixel electrodes PB (or the blue sub-pixels 121B) may be extended toward the second direction Y and the first direction X, such that the areas thereof are, for example, 1.2 units. The areas of the two red sub-pixels 121R′ located at the right side and the lower side of the blue pixel electrodes PB may both be 0.9 units. The green sub-pixels 121G may all be 1 unit. Therefore, in the present embodiment, the areas of the red pixel electrodes PR, the areas of the green pixel electrodes PG, and the areas of the blue pixel electrodes PB may be 0.9*2=1.8 units, 1*2=2 units, and 1*1.2=1.2 units respectively. It may also be understood that the areas of the red pixel electrodes PR, the green pixel electrodes PG, and the blue pixel electrodes PB account for 36%, 40%, and 24% of a pixel respectively. Since the areas of the green pixel electrodes PG are greater, brighter green light and higher contrast may be provided.

Based on the above, the area of the red filter unit 110R, the area of the green filter unit 110G, and the area of the blue filter unit 110B are all substantially the same. Therefore, the electrophoretic display device 10F of the present embodiment may further satisfy the following conditional expressions: RFF≤67%; GFF≤60%; and BFF≤100%. Relevant calculations or principles are as provided in the previous paragraphs and are not repeated herein.

FIG. 7 is a schematic top view of a pixel structure and a color filter array of an electrophoretic display device of an embodiment of the invention. Please refer to FIG. 7. An electrophoretic display device 10G is similar to the electrophoretic display device 10F. The main difference thereof is the extending direction of the blue pixel electrodes PB is different. Specifically, in the electrophoretic display device 10G, the blue pixel electrodes PB (or the blue sub-pixels 121B) are only extended toward the red pixel electrodes PR in the first direction X, and not extended toward the another red pixel electrode PR in the second direction Y, and also not extended toward the green pixel electrodes PG in the first direction X, so that the areas of the green pixel electrodes PG are greater than the areas of the red pixel electrodes PR. From another perspective, the red pixel electrodes PR, the green pixel electrodes PG, and the blue pixel electrodes PB are all extended in the first direction X, i.e., the length is greater in the first direction X, so the red pixel electrodes PR, the green pixel electrodes PG, and the blue pixel electrodes PB may all be rectangles.

For example, in FIG. 7, the blue pixel electrodes PB (or the blue sub-pixels 121B) may be extended toward the reverse direction of the first direction X, so that the areas thereof are, for example, 1.2 units. Moreover, the areas of the red sub-pixels 121R′ located at the upper side of the blue pixel electrodes PB may be 0.8 units, and the areas of the green sub-pixels 121G may all be 1 unit. Therefore, in the present embodiment, the areas of the red pixel electrodes PR, the areas of the green pixel electrodes PG, and the areas of the blue pixel electrodes PB may also be 0.8*+1=1.8 units, 1*2=2 units, and 1*1.2=1.2 units respectively. It may also be understood that the areas of the red pixel electrodes PR, the green pixel electrodes PG, and the blue pixel electrodes PB account for 36%, 40%, and 24% of a pixel respectively. Since the areas of the green pixel electrodes PG are greater, brighter green light and higher contrast may be provided.

Based on the above, the area of the red filter unit 110R, the area of the green filter unit 110G, and the area of the blue filter unit 110B are all substantially the same. Therefore, the electrophoretic display device 10G of the present embodiment may also satisfy the following conditional expressions: RFF≤67%; GFF≤60%; and BFF≤100%. Relevant calculations or principles are as provided in the previous paragraphs and are not repeated herein.

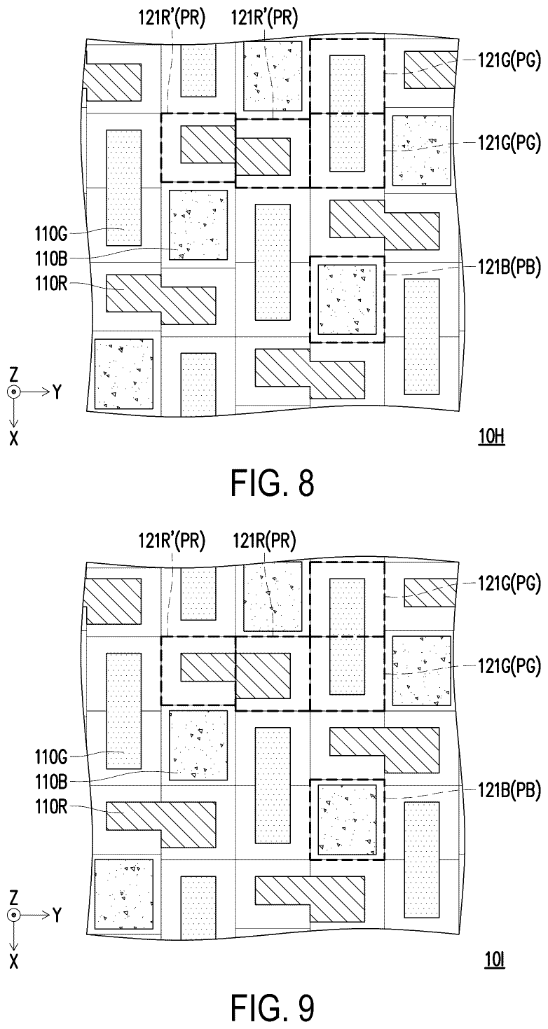

FIG. 8 is a schematic top view of a pixel structure and a color filter array of an electrophoretic display device of an embodiment of the invention. Please refer to FIG. 8. An electrophoretic display device 10H is similar to the electrophoretic display device 10G. The main differences thereof are: the extending directions of the red pixel electrodes PR and the green pixel electrodes PG are different, and the extending direction of the blue pixel electrodes PB is different. Specifically, in the electrophoretic display device 10H, the blue pixel electrodes PB (or the blue sub-pixels 121B) are extended toward the red pixel electrodes PR in the same direction and in the opposite direction of the first direction X, and not extended toward the green pixel electrodes PG in the second direction Y, so that the areas of the green pixel electrodes PG are greater than the areas of the red pixel electrodes PR. From another perspective, two green sub-pixels 121G of a single green pixel electrode PG are both arranged in the first direction X. Therefore, both the blue pixel electrodes PB and the green pixel electrodes PG have a greater length in the first direction X, so that the green pixel electrodes PG and the blue pixel electrodes PB are both rectangles. Two red sub-pixels 121R′ of a single red pixel electrode PR are both arranged in the second direction Y. Therefore, the outline of the red pixel electrodes PR (and the corresponding red filter unit 110R) may be extended and curved in the second direction Y.

Similarly, the areas of the blue pixel electrodes PB (or the blue sub-pixels 121B) of the electrophoretic display device 10H are, for example, 1.2 units. The areas of two red sub-pixels 121R′ of the red pixel electrodes PR located at the upper side of the blue pixel electrodes PB may both be 0.9 units. The areas of the green sub-pixels 121G may all be 1 unit. Therefore, the proportions of the areas of the red pixel electrodes PR, the areas of the green pixel electrodes PG, and the areas of the blue pixel electrodes PB in a pixel may also be 36%, 40%, and 24% respectively; and the electrophoretic display device 10H may also satisfy the following conditional expressions: RFF≤67%; GFF≤60%; and BFF≤100%. Relevant calculations or principles are as provided in the previous paragraphs and are not repeated herein.

FIG. 9 is a schematic top view of a pixel structure and a color filter array of an electrophoretic display device of an embodiment of the invention. Please refer to FIG. 9. An electrophoretic display device 10I is similar to the electrophoretic display device 10H. The main difference thereof is the extending direction of the blue pixel electrodes PB is different. Specifically, in the electrophoretic display device 10I, the blue pixel electrodes PB (or the blue sub-pixels 121B) are only extended toward the red pixel electrodes PR in the opposite direction of the first direction X, and not extended toward the red pixel electrodes PR in the positive direction of the first direction X, and also not extended toward the green pixel electrodes PG in the second direction Y, so that the outline of the red pixel electrodes PR adjacent to the blue pixel electrodes PB is receded in a direction away from the blue pixel electrodes PB (for example, the outline of the red pixel electrodes PR are receded in the opposite direction of the first direction X). The result is that the areas of the green pixel electrodes PG are greater than the areas of the red pixel electrodes PR. From another perspective, the outline of the red pixel electrodes PR may be regarded as a rectangle with one corner missing.

For example, in FIG. 9, the blue pixel electrodes PB (or the blue sub-pixels 121B) may be extended toward the reverse direction of the first direction X, so that the areas thereof are, for example, 1.2 units. The areas of the red sub-pixels 121R′ located at the upper side of the blue pixel electrodes PB may be 0.8 units. The areas of the green sub-pixels 121G may all be 1 unit. Therefore, in the present embodiment, the areas of the red pixel electrodes PR, the areas of the green pixel electrodes PG, and the areas of the blue pixel electrodes PB may also be 0.8*+1=1.8 units, 1*2=2 units, and 1*1.2=1.2 units respectively. It may also be understood that the areas of the red pixel electrodes PR, the areas of the green pixel electrodes PG, and the areas of the blue pixel electrodes PB account for 36%, 40%, and 24% of a pixel respectively. Since the areas of the green pixel electrodes PG are greater, brighter green light and higher contrast may be provided.

Based on the above, the area of the red filter unit 110R, the area of the green filter unit 110G, and the area of the blue filter unit 110B are all substantially the same. Therefore, the electrophoretic display device 10H of the present embodiment may also satisfy the following conditional expressions: RFF≤67%; GFF≤60%; and BFF≤100%. Relevant calculations or principles are as provided in the previous paragraphs and are not repeated herein.

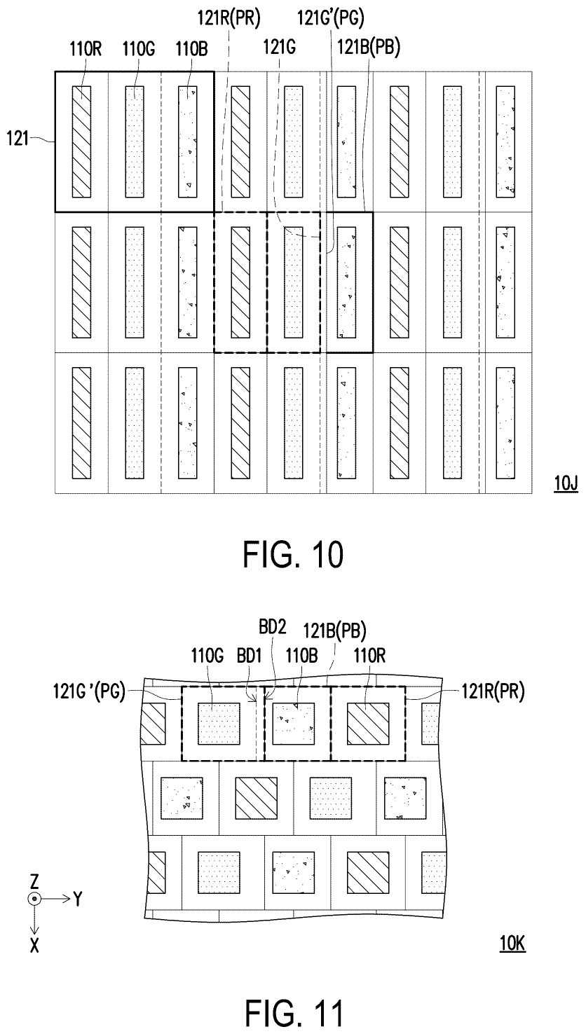

FIG. 10 is a schematic top view of a pixel structure and a color filter array of an electrophoretic display device of an embodiment of the invention. Please refer to FIG. 10. An electrophoretic display device 10J is similar to the electrophoretic display device 10A. The main differences thereof are: the arrangement directions of the red pixel electrodes PR, the green pixel electrodes PG, and the blue pixel electrodes PB are different, and the arrangement directions of the red filter unit 110R, the green filter unit 110G, and the blue filter unit 110B are different. In detail, the electrophoretic display device 10J may include a plurality of pixel units 121, and each of the pixel units 121 includes a red filter unit 110R, a green filter unit 110G, and a blue filter unit 110B; and the corresponding red pixel electrodes PR, green pixel electrodes PG, and blue pixel electrodes PB. Furthermore, in the color filter array 110 (not shown in FIG. 10) of the electrophoretic display device 10J, the arrangement methods of the red filter unit 110R, the green filter unit 110G, and the blue filter unit 110B in each of the pixel units 121 are the same (for example, the order from left to right is always the red filter unit 110R, the green filter unit 110G, and the blue filter unit 110B) and the shapes are all the same (such as rectangle). Similarly, the red pixel electrodes PR of each of the pixel units 121 may all be aligned in the same direction, the green pixel electrodes PG of each of the pixel units 121 may all be aligned in the same direction, and the blue pixel electrodes PB of each of the pixel units 121 may all be aligned in the same direction.

Specifically, in the present embodiment, the area of one red pixel electrode PR may be defined by one red sub-pixel 121R, the area of one green pixel electrode PG may be defined by one green sub-pixel 121G′, and the area of one blue pixel electrode PB may be defined by one blue sub-pixel 121B. It is worth noting that in the present embodiment the areas of the red sub-pixels 121R may be less than the areas of the green pixel electrodes PG (or the green sub-pixels 121G′) and greater than the areas of the blue pixel electrodes PB (or the blue sub-pixels 121B), for example, the red sub-pixels 121R are all 1 unit. Moreover, the areas of the green sub-pixels 121G′ may be extended toward the direction of the blue sub-pixels 121B to be increased. For example, in FIG. 10, the green sub-pixels 121G (indicated by a dotted line) are the green sub-pixels 121G′ (indicated by a solid line), and the areas of the green sub-pixels 121G′ are, for example, 1.2 units. Moreover, the areas of the blue sub-pixels 121B located at the right side of the green pixel electrodes PG may be receded to 0.8 units in a direction away from the green sub-pixels 121G′. Therefore, the areas of the red pixel electrodes PR, the green pixel electrodes PG, and the blue pixel electrodes PB of an embodiment of the invention may also be 1 unit, 1.2 units, and 0.8 units respectively. It may also be understood that the areas of the red pixel electrodes PR, the green pixel electrodes PG, and the blue pixel electrodes PB account for 33.3%, 40%, and 26.7% of a pixel respectively. Since the areas of the green pixel electrodes PG are greater, brighter green light and higher contrast may be provided. Moreover, the architectures of the color filter unit 110 and the pixel structure 120 are simple and easy to design, thus reducing product costs and suitable for improving yield.

Based on the above, the area of the red filter unit 110R, the area of the green filter unit 110G, and the area of the blue filter unit 110B are all substantially the same. Therefore, the electrophoretic display device 10J of the present embodiment may also satisfy the following conditional expressions: RFF≤75%; GFF≤62.5%; and BFF≤93.7%. Relevant calculations or principles are as provided in the previous paragraphs and are not repeated herein.

FIG. 11 is a schematic top view of a pixel structure and a color filter array of an electrophoretic display device of an embodiment of the invention. Please refer to FIG. 11. An electrophoretic display device 10K is similar to the electrophoretic display device 10J. The main differences thereof are: the arrangement directions of the red pixel electrodes PR, the green pixel electrodes PG, and the blue pixel electrodes PB are different, and the arrangement directions of the red filter unit 110R, the green filter unit 110G, and the blue filter unit 110B are different. Specifically, two adjacent pixels of the electrophoretic display device 10K are both of different colors. For example, the pixel electrodes adjacent to the red pixel electrodes PR are all blue pixel electrodes PB or green pixel electrodes PG. The arrangement methods of pixel electrodes of other colors are also as provided above.

Moreover, the areas of the green sub-pixels 121G′ may be increased by extending toward the direction of the blue sub-pixels 121B. Specifically, in FIG. 11, the area of one red pixel electrode PR may be defined by one red sub-pixel 121R, the area of one green pixel electrode PG may be defined by one green sub-pixel 121G′, and the area of one blue pixel electrode PB may be defined by one blue sub-pixel 121B. Moreover, the range of the green sub-pixels 121G′ may be extended from a boundary BD1 to a boundary BD2, and the areas of the green sub-pixels 121G′ are, for example, 1.2 units. The range of the blue sub-pixels 121B located at the right side of the green pixel electrodes PG is receded from the boundary BD1 to the boundary BD2, so that the areas of the blue sub-pixels 121B are 0.8 units. Moreover, the areas of the red sub-pixels 121R are 1 unit. Therefore, the areas of the red pixel electrodes PR, the green pixel electrodes PG, and the blue pixel electrodes PB of an embodiment of the invention may also be 1 unit, 1.2 units, and 0.8 units respectively. It may also be understood that the areas of the red pixel electrodes PR, the green pixel electrodes PG, and the blue pixel electrodes PB account for 33.3%, 40%, and 26.7% of a pixel respectively. Since the areas of the green pixel electrodes PG are greater, brighter green light may be provided. Moreover, the architectures of the color filter unit 110 and the pixel structure 120 are simple and easy to design, thus reducing product costs and suitable for improving yield.

Similar to the above, the area of the red filter unit 110R, the area of the green filter unit 110G, and the area of the blue filter unit 110B are all substantially the same. Therefore, the electrophoretic display device 10J of the present embodiment may also satisfy the following conditional expressions: RFF≤75%; GFF≤62.5%; and BFF≤93.7%. Of course, the disclosure is not limited thereto. In other embodiments not shown, both the areas of the green sub-pixels 121G′ and the areas of the red sub-pixels 121R may be increased by extending toward the direction of the blue sub-pixels 121B. As a result, the areas of the green sub-pixels 121G′ and the areas of the red sub-pixels 121R are greater (for example, both are 1.1 units), and the areas of the blue sub-pixels 121B are less (for example, 0.8 units).

Based on the above, in an embodiment of the invention, since the areas of the green pixel electrodes and the areas of the red pixel electrodes are both greater than the areas of the blue pixel electrodes, the green light and the yellow light displayed by the electrophoretic display device may be brighter, and at the same time the blue light displayed may be darker, thus effectively improving the contrast and the chroma of the display screen. Moreover, since the area of the red filter unit, the area of the green filter unit, and the area of the blue filter unit are all substantially the same, the pixel coverage (i.e., BFF) of the blue filter unit is greater than the pixel coverage (i.e., GFF) of the green filter unit and the pixel coverage (i.e., RFF) of the red filter unit. Therefore, while adjusting the brightness of the display of the primary color light, the white balance of the electrophoretic display device may also be maintained to alleviate the color shift issue of the electrophoretic display device and effectively improve the contrast and the display quality of the electrophoretic display device.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An electrophoretic display device, comprising:
a pixel structure comprising a red pixel electrode, a green electrode, and a blue pixel electrode, wherein an area of the blue pixel electrode is less than an area of the red pixel electrode, and the area of the blue pixel electrode is less than an area of the green pixel electrode; and
a color filter array overlapped with the pixel structure, the color filter array comprising:
a red filter unit overlapped with the red pixel electrode, and a ratio of an area of the red filter unit to the area of the red pixel electrode is RFF;
a green filter unit overlapped with the green pixel electrode, and a ratio of an area of the green filter unit to the area of the green pixel electrode is GFF; and
a blue filter unit overlapped with the blue pixel electrode, and a ratio of an area of the blue filter unit to the area of the blue pixel electrode is BFF,
wherein the ratios of the areas satisfy a following conditional expression: BFF>RFF≥GFF.

2. The electrophoretic display device of claim 1, further satisfying following conditional expressions: RFF≤75%; GFF≤62.5%; and BFF≤93.7%.

3. The electrophoretic display device of claim 1, further satisfying following conditional expressions: RFF≤63%; GFF≤63%; and BFF≤100%.

4. The electrophoretic display device of claim 1, further satisfying following conditional expressions: RFF≤67%; GFF≤60%; and BFF≤100%.

5. The electrophoretic display device of claim 1, wherein a display surface of the electrophoretic display device has a first direction and a second direction perpendicular to each other, the blue pixel electrode is extended in the first direction and the second direction respectively, so that an outline of the red pixel electrode adjacent to the blue pixel electrode and an outline of the green pixel electrode adjacent to the blue pixel electrode are both receded in a direction away from the blue pixel electrode.

6. The electrophoretic display device of claim 5, wherein the outline of the blue pixel electrode is a cross shape, and two vertical ends of the cross shape are extended toward the first direction and the second direction respectively.

7. The electrophoretic display device of claim 1, wherein a display surface of the electrophoretic display device has a first direction and a second direction perpendicular to each other, the red pixel electrode, the green pixel electrode, and the blue pixel electrode all have a same width in the second direction, and the red pixel electrode, the green pixel electrode, and the blue pixel electrode are all extended in the first direction.

8. The electrophoretic display device of claim 1, wherein an outline of the blue pixel electrode is essentially a circle, so that an outline of the red pixel electrode adjacent to the blue pixel electrode and an outline of the green pixel electrode adjacent to the blue pixel electrode are both receded in a direction away from the blue pixel electrode.

9. The electrophoretic display device of claim 1, further comprising another red pixel electrode, wherein a display surface of the electrophoretic display device has a first direction and a second direction perpendicular to each other, the red pixel electrode and the another red pixel electrode are respectively located in the first direction and the second direction of the blue pixel electrode, and the blue pixel electrode is extended toward the red pixel electrode and toward the another red pixel electrode, so that an outline of the red pixel electrode adjacent to the blue pixel electrode and an outline of the another red pixel electrode are both receded in a direction away from the blue pixel electrode.

10. The electrophoretic display device of claim 1, wherein the blue pixel electrode is extended toward the red pixel electrode, so that an outline of the red pixel electrode adjacent to the blue pixel electrode is receded in a direction away from the blue pixel electrode.

11. The electrophoretic display device of claim 1, wherein a shape of the red filter unit is the same as a shape of the red pixel electrode, a shape of the green filter unit is the same as a shape of the green pixel electrode, and a shape of the blue filter unit is the same as a shape of the blue pixel electrode.

12. The electrophoretic display device of claim 1, wherein the green pixel electrode is extended toward the blue pixel electrode, so that an outline of the blue pixel electrode adjacent to the green pixel electrode is receded in a direction away from the green pixel electrode.

13. The electrophoretic display device of claim 1, further comprising:
an electrophoretic display film disposed between the pixel structure and the color filter array, and the electrophoretic display film comprises a microcapsule electrophoretic structure or a microcup electrophoretic structure.

14. The electrophoretic display device of claim 1, wherein the area of the red filter unit, the area of the green filter unit, and the area of the blue filter unit are substantially the same.
